(19) United States
(12) Patent Application Publication
(10) Pub. No.: US 2007/0038465 A1
(43) Pub. Date: Feb. 15, 2007

(54) Value model

(75) Inventors: Yunhee Jang, Poughkeepsie, NY (US); Juhnyoung Lee, Yorktown Heights, NY (US); Grace Y. Lin, Chappaqua, NY (US); David D. Yao, New York, NY (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/200,727

(22) Filed: Aug. 10, 2005

(51) Int. Cl. G06Q 99/00

(52) U.S. Cl. 705/1

(57) ABSTRACT

A value model that can be used to value an enterprise function is provided. The value model includes one or more levels of enterprise function nodes that are related to each other and/or a bottom level of driver metric nodes, such as driver metric nodes in a value driver graph. The modification to one or more enterprise function nodes can be received and a value impact of the modification can be determined based on the modification and the relationships in the value model. In this manner, the value model provides an effective manner for determining a value impact on a particular value measurement that a specific enterprise function, such as an information technology solution/service, provides/is expected to provide.

### REFERENCE TO RELATED APPLICATION

The current application is related to co-owned and co-pending U.S. Patent Application No. ______ (Attorney Docket No. END920050068US1), filed on Aug. 10, 2005, and entitled “Business Solution Evaluation”, which is hereby incorporated herein by reference.

### FIELD OF THE INVENTION

The invention relates generally to business analysis, and more particularly, to a value model that can be used to analytically value an enterprise function.

### BACKGROUND OF THE INVENTION

Current return on investment (ROI) analysis provides a calculation used to determine whether a proposed investment is wise, and how well it will repay the investor. In general, the calculation comprises a ratio of an amount gained/lost relative to the cost basis. These ROI techniques are implemented in a project-based manner and/or a particular activity or capability using deterministic models. To this extent, current ROI techniques fail to relate benefits obtained for an enterprise function (e.g., a business activity, information technology capability, etc) to a higher-level strategic business value. Further, current solutions are limited in that they do not take into account other factors, such as a possible correlation between two or more activities/capabilities, uncertainty in a value relationship, and the like.

To this extent, a need exists for an improved value model that addresses these needs and/or other needs not expressly discussed herein.

### SUMMARY OF THE INVENTION

The invention provides a value model that can be used to value an enterprise function. The value model includes one or more levels of enterprise function nodes that are related to each other and/or a bottom level of driver metric nodes, such as driver metric nodes in a value driver graph. The modification to one or more enterprise function nodes can be received and a value impact of the modification can be determined based on the modification and the relationships in the value model. In this manner, the value model provides an effective manner for determining a value impact on a particular value measurement that a specific enterprise function, such as an information technology solution/service, provides/is expected to provide. In one embodiment, some relationship data in the value model includes an uncertainty range, thereby providing a more flexible measurement of the modification. Further, the value model can include aggregate relationship data, which can be used to account for any dependencies (e.g., synergistic, cannibalistic, statistical) that may be present among different relationships.

A first aspect of the invention provides a method of managing a value model for use in valuing an enterprise function, the method comprising: generating the value model by: obtaining a first set of enterprise function nodes for a first enterprise level of the value model; obtaining a value driver graph, wherein the value driver graph includes a plurality of driver levels each of which includes at least one driver metric node, and wherein the value driver graph includes a set of driver relationships, wherein each driver relationship defines an impact that at least one driver metric node in a lower driver level has on a driver metric node in a higher driver level; and obtaining a first set of value relationships between the first set of enterprise function nodes and a set of driver metric nodes in a lowest driver level.

A second aspect of the invention provides a system for managing a value model for use in valuing an enterprise function, the system comprising: a system for generating the value model, the system for generating including: a system for obtaining a first set of enterprise function nodes for a first enterprise level of the value model; a system for obtaining a value driver graph, wherein the value driver graph includes a plurality of driver levels each of which includes at least one driver metric node, and wherein the value driver graph includes a set of driver relationships, wherein each driver relationship defines an impact that at least one driver metric node in a lower driver level has on a driver metric node in a higher driver level; and a system for obtaining a first set of value relationships between the first set of enterprise function nodes and a set of driver metric nodes in a lowest driver level.

A third aspect of the invention provides a program product stored on a computer-readable medium, which when executed, enables a computer infrastructure to manage a value model, the program product comprising computer program code for enabling the computer infrastructure to perform the steps of: generating the value model by: obtaining a first set of enterprise function nodes for a first enterprise level of the value model; obtaining a value driver graph, wherein the value driver graph includes a plurality of driver levels each of which includes at least one driver metric node, and wherein the value driver graph includes a set of driver relationships, wherein each driver relationship defines an impact that at least one driver metric node in a lower driver level has on a driver metric node in a higher driver level; and obtaining a first set of value relationships between the first set of enterprise function nodes and a set of driver metric nodes in a lowest driver level.

A fourth aspect of the invention provides a method of valuing an enterprise function, the method comprising: obtaining a value model, wherein the value model includes: a plurality of levels, each of which includes at least one node representing one of an enterprise function or a value driver; and a set of relationships, each of which defines a relationship between a first node on a first level and a second node on an adjacent level to the first level; receiving a modification to the value model; and recursively determining a value impact of the modification on a value measurement node in the value model.

A fifth aspect of the invention provides a system for valuing an enterprise function, the system comprising: a system for obtaining a value model, wherein the value model includes: a plurality of levels, each of which includes at least one node representing one of an enterprise function or a value driver; and a set of relationships, each of which defines a relationship between a first node on a first level and a second node on an adjacent level to the first level; a system for receiving a modification to the value model; and a system for recursively determining a value impact of the modification on a value measurement node in the value model.

A sixth aspect of the invention provides a program product stored on a computer-readable medium, which when executed, enables a computer infrastructure to value an enterprise function, the program product comprising computer program code for enabling the computer infrastructure to perform the steps of: obtaining a value model, wherein the value model includes: a plurality of levels, each of which includes at least one node representing one of an enterprise function or a value driver; and a set of relationships, each of which defines a relationship between a first node on a first level and a second node on an adjacent level to the first level; receiving a modification to the value model; and recursively determining a value impact of the modification on a value measurement node in the value model.

A seventh aspect of the invention provides a method of generating a system for managing a value model, the method comprising: providing a computer infrastructure operable to: generate the value model by: obtaining a first set of enterprise function nodes for a first enterprise level of the value model; obtaining a value driver graph, wherein the value driver graph includes a plurality of driver levels each of which includes at least one driver metric node, and wherein the value driver graph includes a set of driver relationships, wherein each driver relationship defines an impact that at least one driver metric node in a lower driver level has on a driver metric node in a higher driver level; and obtaining a first set of value relationships between the first set of enterprise function nodes and a set of driver metric nodes in a lowest driver level.

An eighth aspect of the invention provides a method of generating a system for valuing an enterprise function, the method comprising: providing a computer infrastructure operable to: obtain a value model, wherein the value model includes: a plurality of levels, each of which includes at least one node representing one of an enterprise function or a value driver; and a set of relationships, each of which defines a relationship between a first node on a first level and a second node on an adjacent level to the first level; receive a modification to the value model; and recursively determine a value impact of the modification on a value measurement node in the value model.

A ninth aspect of the invention provides a business method for managing a value model and/or valuing an enterprise function, the business method comprising managing a computer infrastructure that performs one or more of the steps of the invention; and receiving payment based on the managing step.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative environment for valuing an enterprise function according to one embodiment of the invention.

FIG. 2 shows a prior art value driver graph.

FIG. 3 shows an illustrative value model according to one embodiment of the invention.

FIGS. 4A-C show illustrative interfaces for displaying/entering relationship data.

FIG. 5 shows illustrative method steps for determining a value impact of a modification according to one embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### BEST MODE FOR CARRYING OUT THE INVENTION

As indicated above, the invention provides a value model that can be used to value an enterprise function. The value model includes one or more levels of enterprise function nodes that are related to each other and/or a bottom level of driver metric nodes, such as driver metric nodes in a value driver graph. The modification to one or more enterprise function nodes can be received and a value impact of the modification can be determined based on the modification and the relationships in the value model. In this manner, the value model provides an effective manner for determining a value impact on a particular value measurement that a specific enterprise function, such as an information technology solution/service, provides/is expected to provide. In one embodiment, some relationship data in the value model includes an uncertainty range, thereby providing a more flexible measurement of the modification. Further, the value model can include aggregate relationship data, which can be used to account for any dependencies (e.g., synergistic, cannibalistic, statistical) that may be present among different relationships.

As used herein, “enterprise function” represents a capability, ability, and/or activity that an enterprise includes and/or performs. For example, an enterprise function can comprise a business activity that comprises a piece of work into which a business process is organized, and which is performed during the course of business to contribute to the generation and/or provision of products/services by the enterprise. Similarly, an enterprise function can comprise one or more elements of an infrastructure of the enterprise and/or one or more elements that an enterprise is considering to adopt for its infrastructure. To this extent, an infrastructure element can comprise an information technology (IT) capability (e.g., one or more software applications, a service for supporting a business activity, hardware, or the like) of the enterprise, a physical asset (e.g., an automobile) of the enterprise, or the like. Different types of enterprise functions can be related to one another. For example, an infrastructure element enterprise function can be related to a business activity enterprise function based on the use/potential use of the infrastructure element in performing the business activity. Further, as used herein, the term “set” means one or more.

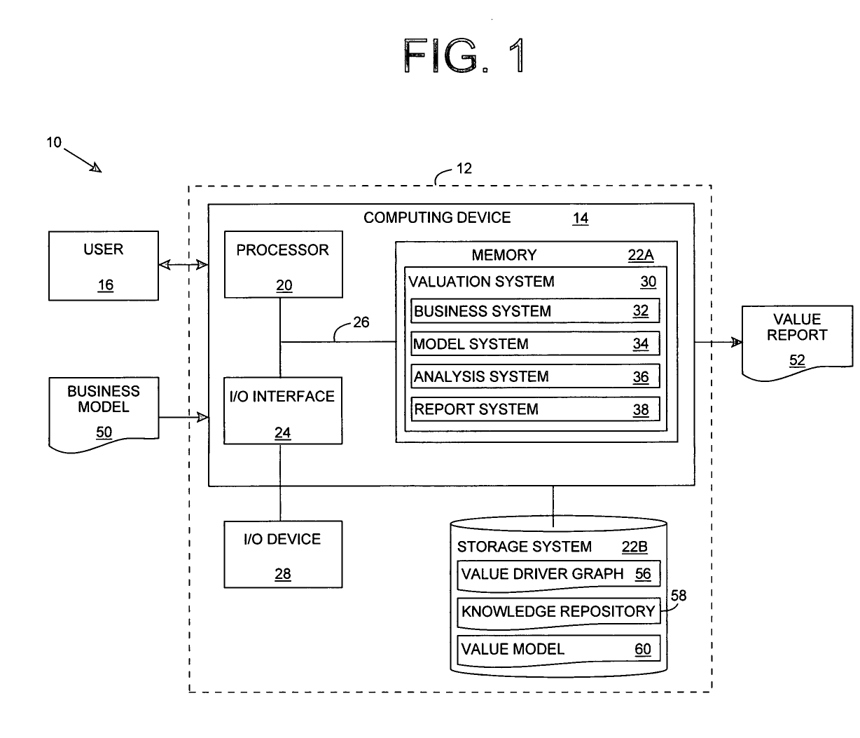

Turning to the drawings, FIG. 1 shows an illustrative environment 10 for valuing an enterprise function. To this extent, environment 10 includes a computer infrastructure 12 that can perform the various process steps described herein for valuing an enterprise function using one or more value models 60. In particular, computer infrastructure 12 is shown including a computing device 14 that comprises a valuation system 30, which enables computing device 14 to value an enterprise function by performing some or all of the process steps described herein.

Computing device 14 is shown including a processor 20, a memory 22A, an input/output (I/O) interface 24, and a bus 26. Further, computing device 14 is shown in communication with an external I/O device/resource 28 and a storage system 22B. As is known in the art, in general, processor 20 executes computer program code, such as valuation system 30, that is stored in memory 22A and/or storage system 22B. While executing computer program code, processor 20 can read and/or write data, such as value model 60, to/from memory 22A, storage system 22B, and/or I/O interface 24. Bus 26 provides a communications link between each of the components in computing device 14. I/O device 28 can comprise any device that enables user 16 to interact with computing device 14 or any device that enables computing device 14 to communicate with one or more other computing devices.

In any event, computing device 14 can comprise any general purpose computing article of manufacture capable of executing computer program code installed by a user 16 (e.g., a personal computer, server, handheld device, etc.). However, it is understood that computing device 14 and valuation system 30 are only representative of various possible equivalent computing devices that may perform the various process steps of the invention. To this extent, in other embodiments, computing device 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computing devices (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computing devices may utilize any combination of various types of transmission techniques. Further, user 16 can utilize another computing device (not shown) in communication with computer infrastructure 12 over any type of communications link, such as the Internet, to value an enterprise function using valuation system 30.

As previously mentioned and discussed further below, valuation system 30 enables computing infrastructure 12 to value an enterprise function. To this extent, valuation system 30 is shown including a business system 32, a model system 34, an analysis system 36, and a report system 38. The operation of each of these systems is discussed further below. However, it is understood that some of the various systems shown in FIG. 1 can be implemented independently, combined, and/or stored in memory for one or more separate computing devices that are included in computer infrastructure 12. Further, it is understood that some of the systems and/or functionality may not be implemented, or additional systems and/or functionality may be included as part of environment 10 and/or valuation system 30.

Regardless, the invention provides a solution for valuing an enterprise function using a value model 60. To this extent, valuation system 30 can comprise a model system 34 for managing value model 60. To this extent, model system 34 can obtain value model 60 using any solution. In particular, model system 34 can enable user 16 to generate and/or modify one or more value models 60, receive value model 60 communicated from another system, and/or the like. Further, model system 34 can generate one or more user interfaces that enable user 16 to selectively add, remove, and/or modify content of value model 60.

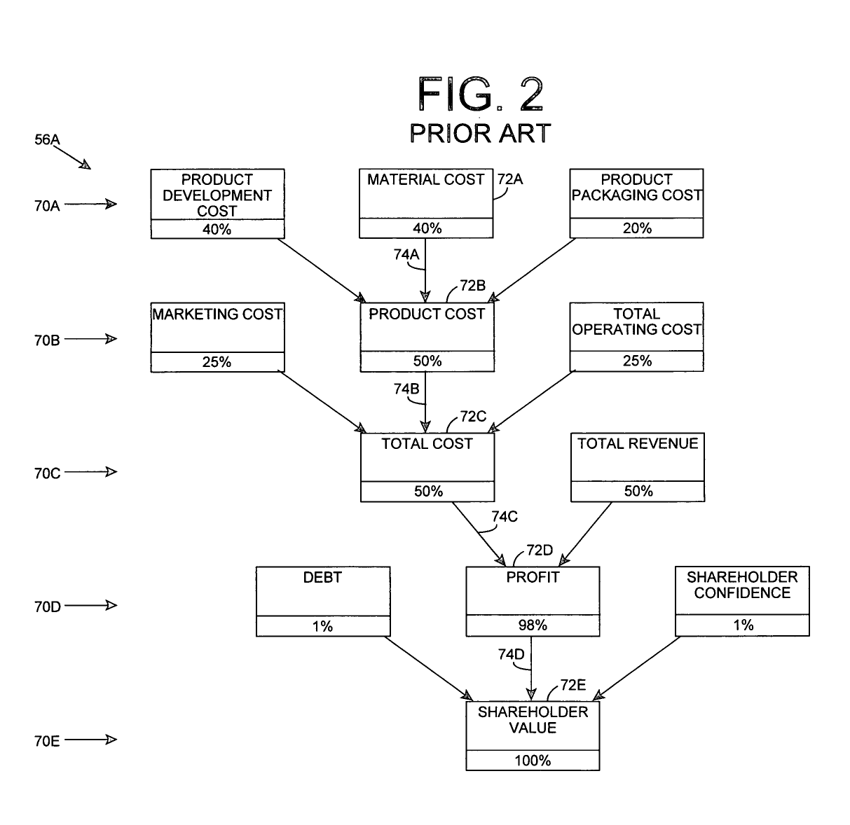

In one embodiment, model system 34 generates value model 60 using a value driver graph 56. To this extent, model system 34 can obtain value driver graph 56 using any known solution. For example, value driver graph 56 can be selected by user 16, communicated from another system, and/or model system 34 can generate a user interface that enables user 16 to create and/or modify value driver graph 56. In any event, FIG. 2 shows a prior art value driver graph 56A. As shown, value driver graph 56A comprises a plurality of driver levels 70A-E. Each driver level 70A-E includes at least one driver metric node, such as driver metric nodes 72A-E. Driver metric nodes 72A-E each represent a unique business measure, such as a cost, a revenue, a value, etc. To this extent, each driver metric node 72A-E can include a numeric value for the business measure. It is understood that the particular business measures shown in value driver graph 56A are only illustrative, and various business measures can be included.

Value driver graph 56A comprises a directed graph. In particular, value driver graph 56A includes a set of driver relationships, such as driver relationships 74A-D. Driver relationships 74A-D define relationships between driver metric nodes 72A-D on a lower driver level 70A-D and driver metric nodes 72B-E on a higher driver level 70B-E. Each driver relationship 74A-D defines a relative impact that a driver metric node 72A-E has on another driver metric node 72A-E on an adjacent higher driver level 70A-E. As shown, the relative impact can be expressed as a percentage that the lower driver metric node 72A-E contributes to the overall numeric value of the higher driver metric node 72A-E. In this case, when multiple driver metric nodes 72A-E impact another driver metric node 72A-E, the sum of the impact percentages should be less than or equal to one hundred percent. It is understood that value driver graph 56A is only illustrative. To this extent, value driver graph 56A could include additional or fewer driver levels 70A-E, each of which includes additional and/or fewer driver metric nodes 72A-E.

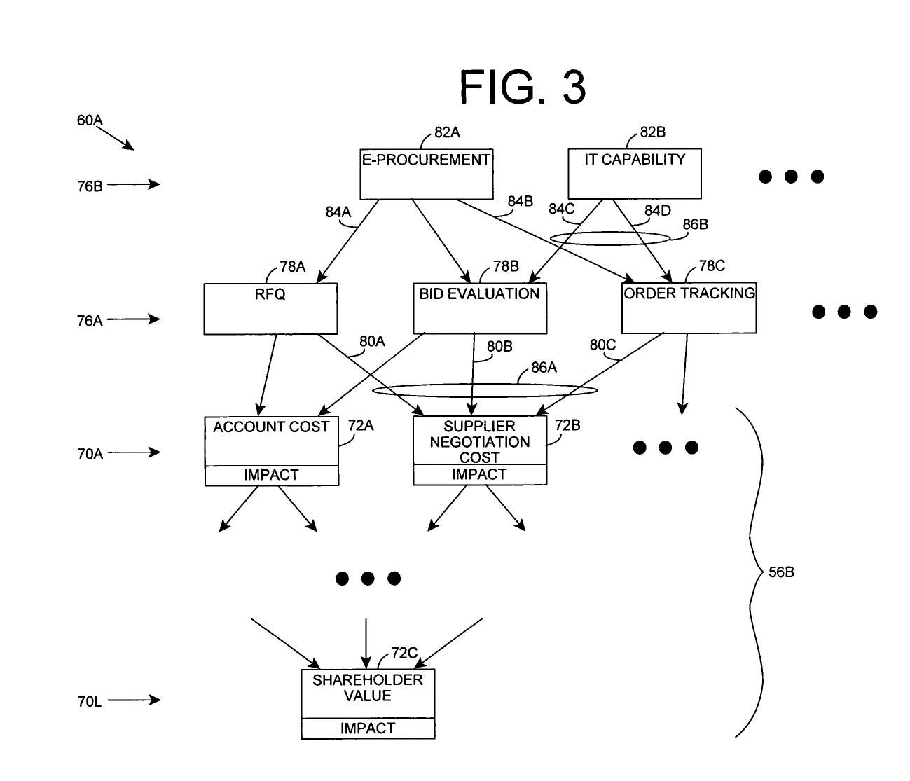

Returning to FIG. 1, model system 34 can generate value model 60 by extending and/or enhancing value driver graph 56. FIG. 3 shows an illustrative value model 60A according to one embodiment of the invention. Referring to FIGS. 1 and 3, in generating value model 60A, model system 34 can add a set of enterprise nodes each representing an enterprise function to a set (one or more) of enterprise levels 76A-B of value model 60A. To this extent, value model 60A includes a value driver graph 56B that includes a lowest level 70A and a highest level 70L, each of which includes one or more driver metric nodes 72A-C. Model system 34 can obtain one or more sets of enterprise function nodes 78A-C, 82A-B, which can be added to a corresponding one or more enterprise levels 76A-B that are located below lowest level 70A of value driver graph 56B.

Subsequently, model system 34 can obtain a set of value relationships 80A-C between enterprise function nodes 78A-C on the highest enterprise level 76A and one or more driver metric nodes 72A-B on lowest level 70A of value driver graph 56B. Similarly, model system 34 can obtain another set of value relationships 84A-D between enterprise function nodes 82A-B located on a lower enterprise level 76B and enterprise function nodes 78A-C located on a higher enterprise level 76A. It is understood that while two enterprise levels 76A-B are shown, value model 60A can include any number of enterprise levels 76A-B. Each enterprise level 76A-B can comprise enterprise function nodes 78A-C, 82A-B that represent a particular type of enterprise function. In one embodiment, enterprise function nodes 78A-C each represent a business activity, while enterprise function nodes 82A-B each represent an information technology capability.

Model system 34 can obtain enterprise function nodes 78A-C, 82A-B using any solution. For example, model system 34 can generate a user interface that enables user 16 to add, delete, modify, etc., enterprise function nodes 78A-C, 82A-B. Additionally, model system 34 can obtain enterprise function nodes 78A-C, 82A-B from another system. For example, business system 32 can obtain a business model 50. Business model 50 can comprise any representation of various components of a business, such as a target enterprise. In one embodiment, business model 50 is formatted based on IBM's component business model (CBM). In any event, business system 32 can extract enterprise function nodes 78A-C, 82A-B from business model 50 and provide the extracted enterprise function nodes 78A-C, 82A-B to model system 34 for use in generating value model 60A.

Similarly, model system 34 can obtain value relationships 80A-C, 84A-D using any solution. For example, model system 34 can generate a user interface that enables user 16 to add, delete, modify, etc., value relationships 80A-C, 84A-D. Additionally, model system 34 can receive value relationships 80A-C, 84A-D from another system and/or from an external database. To this extent, in one embodiment, model system 34 obtains a set of default value relationships 80A-C, 84A-D from a knowledge repository 58. Knowledge repository 58 can include value relationships that have been previously used for a similar type of enterprise (e.g., in another value model 60A), are defined by a best practice, an industry standard, a benchmark, or the like.

Each value relationship 80A-C, 84A-D can define how an enterprise function node 78A-C, 82A-B on a lower level of value model 60A impacts an enterprise function node 78A-C and/or driver metric node 72A-B on an adjacent higher level of value model 60A. Impact can be defined in various ways. For example, impact can be defined as a predicted performance improvement of a value/activity/capability represented by a higher node by performing an activity and/or using a capability represented by a lower node. Similarly, impact can comprise an expected percentage improvement of a higher value due to a unit improvement of a lower value. Additionally, impact can include an expected usage factor of an activity, e.g., what percentage of the time a lower activity/capability will be used in generating/performing a higher value/activity.

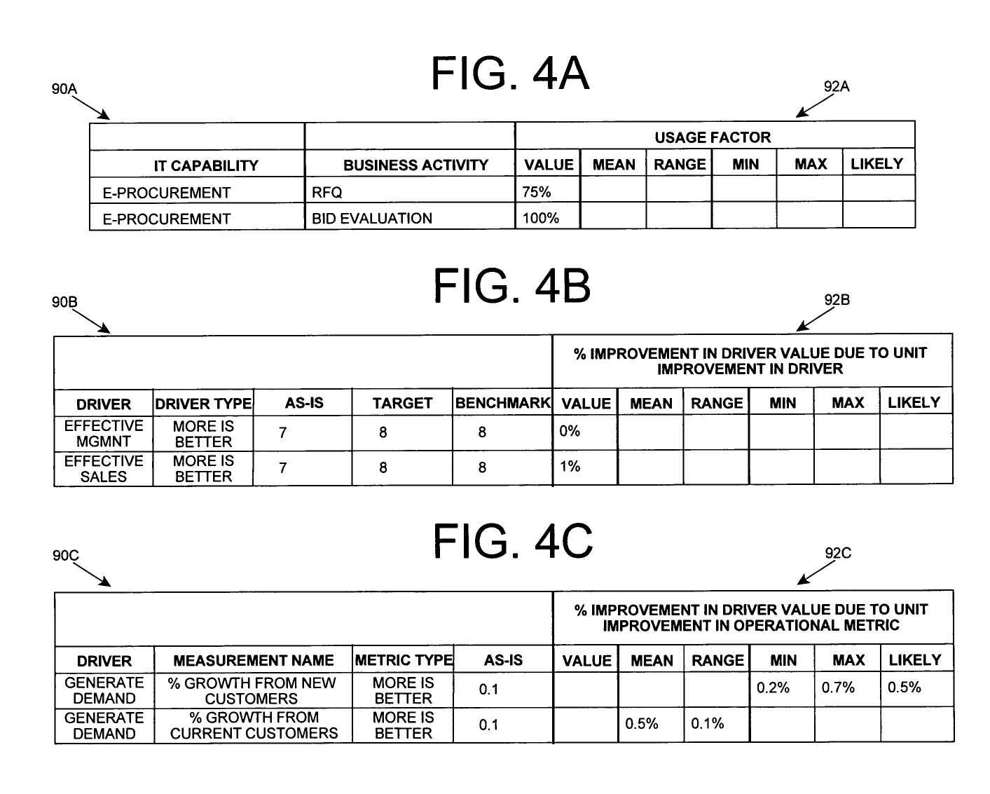

One or more relationships (e.g., value relationships 80A-C, 84A-D and driver relationships 74A-D of FIG. 2) in value model 60A can include an uncertainty range. To this extent, an impact can be expressed as a mean/range, a most likely/minimum/maximum, a specific value, or the like. Data for each relationship can be entered using any known solution. For example, FIGS. 4A-C show illustrative interfaces 90A-C for displaying/entering relationship data 92A-C for illustrative relationships. In each interface 90A-C, relationship data 92A-C can be represented in one of three formats: a specific value; a mean/range pair of values; or a min/max/most likely trio of values. It is understood that interfaces 90A-C are only illustrative and any solution can be used for enabling a user 16 (FIG. 1) to view/modify relationship data 92A-C. To this extent, interface 90A-C could be displayed as a pop up window or the like in response to a user selection of a particular relationship in value model 60A (FIG. 3).

In FIG. 4A, relationship data 92A defines a usage factor relationship between a lower enterprise function (e.g., e-procurement IT capability) and a higher enterprise function (e.g., request for quotation (RFQ)/bid evaluation business activities). In particular, relationship data 92A represents a percentage of time that the lower enterprise function (e.g., e-procurement) will be used when the higher enterprise function (e.g., RFQ) is performed. A value of less than one hundred percent would indicate that some other enterprise function is used the remainder of the time. In FIG. 4B, relationship data 92B defines a relative impact that a particular driver metric (e.g., effective management, effective sales) has on any related higher driver metric(s). In one case, a one unit improvement will not result in any impact, while in the other case, a one unit improvement will result in a one percent improvement. In FIG. 4C, relationship data 92C defines a predicted impact that a lower driver metric (e.g., demand generation) has on a particular higher metric (e.g., new/current customer growth). In this case, relationship data 92C includes one relationship expressed as a most likely/minimum/maximum (e.g., most likely 0.5% improvement with a low of 0.2% and a high of 0.7%) and another relationship expressed as a mean/range (e.g., 0.5% +/− 0.1% improvement or 0.4% to 0.6% improvement).

Returning to FIGS. 1 and 3, value model 60A can further include aggregate information. To this extent, model system 34 can obtain a set of aggregate relationships 86A-B, each of which defines a dependency between two or more relationships (e.g., value relationships 80A-C, 84A-D and driver relationships 74A-D of FIG. 2) using any solution. For example, aggregate relationship 86A could comprise synergistic information, such as an inflation factor between relationships 80A-C. In this case, when all three relationships 80A-C are implemented, an aggregate improvement may be enhanced by the inflation factor above the sum of the improvements of each individual relationship 80A-C. Further, aggregate relationship 86A could comprise cannibalistic information, such as a deflation factor indicating a decrease in the overall improvement when two or more relationships 80A-C are implemented. Similarly, aggregate relationship 86B could define a statistical relationship between two or more relationships 84C-D. In this case, aggregate relationship 86B can define an expected statistical dependency, such as a correlation, between the relationships 84C-D. In any event, each aggregate relationship 86A-B can comprise data that is represented in the same manner as that of driver/value relationships. To this extent, an aggregate relationship can comprise a specific value and/or an uncertainty range (e.g., mean/range, min/max/most likely).

In addition to managing one or more value models 60, valuation system 30 can value an enterprise function using value model 60. To this extent, analysis system 36 can receive a modification to value model 60 using any known solution. For example, analysis system 36 could generate an interface that enables user 16 to make one or more modifications. Alternatively, analysis system 36 can receive the modification from another system (e.g., model system 34). In any event, the modification could comprise a change in a value of a node (e.g., driver node or enterprise function node), an addition/removal of a node, an addition/removal of a relationship, a change in relationship data, and/or the like.

Subsequently, analysis system 36 can determine a value impact of the modification on one or more value measurement nodes in value model 60A (FIG. 3). A value measurement node can comprise any value metric node 72A-C that impacted by the modification and is being analyzed by, for example, user 16. Typically, a value measurement node will be located at a top level 70L of value model 60A. However, the value measurement node(s) could be located in any level in value model 60A above the level of the modification(s).

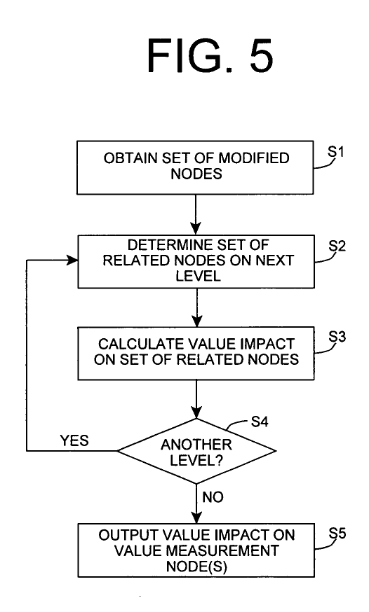

Analysis system 36 can recursively determine the value impact. For example, FIG. 5 shows illustrative method steps for determining the value impact according to one embodiment of the invention. In step S1, analysis system 36 can obtain a set of modified nodes. The set of modified nodes could comprise one or more added nodes, one or more nodes whose corresponding value was changed and/or one or more nodes from which a relationship to a higher node was changed/added. In step S2, analysis system 36 can determine, for a next succeeding level in value model 60 (FIG. 1), a set of related nodes to the set of modified nodes. These nodes would comprise the set of nodes for which a relationship to one or more of the modified nodes is defined in value model 60. In step S3, analysis system 36 can calculate a value impact on each node in the set of related nodes. In particular, analysis system 36 can use the value of each modified node and the relationship data to calculate a change to the value of each related node. When relationship data includes an uncertainty range, then the value impact can include a corresponding uncertainty range. Additionally, when one or more relationships comprise an aggregate relationship, this can be included in the calculation in a known manner. For example, an inflation/deflation factor can be used to adjust the mean up/down. In step S4, analysis system 36 can determine if another succeeding level in value model 60 is present, and if so, flow can return to step S2. Otherwise, flow can proceed to step S5, in which analysis system 36 can output a value impact for each value measurement node. It is understood that when one or more relationships include an uncertainty range, the value impact for a value measurement node can also include an uncertainty range.

Returning to FIG. 1, valuation system 30 can output a value report 52 based on the value impact(s). To this extent, report system 38 can receive data on the value impact(s) from analysis system 36 and generate value report 52. Value report 52 can comprise data on the modification and its resulting impact on one or more value measurement nodes. Additionally, value report 52 can comprise data on the value impact to one or more intermediate nodes in value model 60. In any event, value report 52 can comprise any type of human readable and/or machine readable format.

The present invention can be used before, during, or after the sale of a business solution that includes enterprise functionality, such as an IT solution/service, to articulate the business value and/or business risk. In this case, the invention will help provide faster a response to a customer, shorten the sales cycle time, lower sales and delivery cost, develop new insights in business cases, and guide the project implementation. This invention can also be used by an enterprise to assess the value of its investment in enterprise functionality.

Further, the invention can be used in value-pricing, which facilitates determining a service contract pricing model. In this case, value model 60 (FIG. 1) can provide decision support for selecting a service contract pricing model, can provide visibility into business value/benefit realization and the associated cost/performance risk, and/or help identify value/cost drivers of service initiatives and set the right service level agreement between the service provider and service receiver. The invention can provide support for a service provider's and/or a service receiver's decision-making process in selecting an appropriate contract pricing model for business initiatives. Additionally, the invention can help manage in-delivery and/or after-delivery services by monitoring project performances against a targeted business value-driver performance level. Moreover, the invention can facilitate the implementation of an end-to-end gain/risk sharing between service provider and service receiver.

Still further, the invention can be used in project portfolio optimization and management. Project portfolio optimization provides decision support for selecting candidate investments, prioritizes transformations initiatives/projects based on their potential to improve business performance, maximizes the value delivered by initiatives and at the same meet constraints such as budget and resource, and balances the overall portfolio with enterprise objectives. Project portfolio management provides visibility into project performance, helps manage a dynamic portfolio of business transformation initiatives, and monitors financial, operational metrics for transformation initiatives/projects. The invention can support an enterprise's decision in dynamically managing a portfolio of enterprise functions, such as IT applications and capabilities, so as to optimize the utility (business objectives) of the enterprise, taking into account constraints (such as budget) and the risk-return profiles (in probability and confidence interval) of the IT capabilities.

While shown and described herein as a method and system for managing a value model 60 (FIG. 1) and/or valuing an enterprise function, it is understood that the invention further provides various alternative embodiments. For example, in one embodiment, the invention provides a program product stored on a computer-readable medium, which when executed, enables a computer infrastructure to manage value model 60 and/or value an enterprise function. To this extent, the computer-readable medium includes program code, such as valuation system 30 (FIG. 1), that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22A (FIG. 1) and/or storage system 22B (FIG. 1) (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider, such as an Internet Service Provider, could offer to managing a value model 60 (FIG. 1) and/or valuing an enterprise function as described above. In this case, the service provider can manage (e.g., create, maintain, support, etc.) a computer infrastructure, such as computer infrastructure 12 (FIG. 1), that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for managing a value model 60 (FIG. 1) and/or valuing an enterprise function. In this case, a computer infrastructure, such as computer infrastructure 12 (FIG. 1), can be provided (e.g., created, maintained, having made available to, etc.) and one or more systems for performing the process steps of the invention can be obtained (e.g., created, purchased, used, modified, etc.) and deployed to the computer infrastructure to make the computer infrastructure operable to perform one or more of the steps described herein. To this extent, the deployment of each system can comprise one or more of (1) installing program code on a computing device, such as computing device 14 (FIG. 1), from a computer-readable medium; (2) adding one or more computing devices to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of managing a value model for use in valuing an enterprise function, the method comprising:
generating the value model by:
obtaining a first set of enterprise function nodes for a first enterprise level of the value model;
obtaining a value driver graph, wherein the value driver graph includes a plurality of driver levels each of which includes at least one driver metric node, and wherein the value driver graph includes a set of driver relationships, wherein each driver relationship defines an impact that at least one driver metric node in a lower driver level has on a driver metric node in a higher driver level; and
obtaining a first set of value relationships between the first set of enterprise function nodes and a set of driver metric nodes in a lowest driver level.

2. The method of claim 1, wherein the generating step further includes:
obtaining a second set of enterprise function nodes for a second enterprise level of the value model; and
obtaining a second set of value relationships between the second set of enterprise function nodes and the first set of enterprise function nodes.

3. The method of claim 2, wherein the first set of enterprise function nodes represents a set of business activities and wherein the second set of enterprise function nodes represents a set of information technology capabilities.

4. The method of claim 1, wherein the generating step further includes obtaining a set of aggregate relationships for the first set of value relationships, wherein each aggregate relationship defines a dependency between at least two of the set of value relationships.

5. The method of claim 1, further comprising:
receiving a modification to the value model; and
recursively determining a value impact of the modification on a value measurement node in the value model.

6. The method of claim 5, wherein the recursively determining step includes:
obtaining a set of modified nodes based on the modification;
for each succeeding level in the value model,
determining a set of related nodes to the set of modified nodes; and
calculating a value impact for each node in the set of related nodes based on the value impact of each related node in a previous level.

7. The method of claim 1, wherein the obtaining a first set of value relationships step includes obtaining a set of default value relationships from a knowledge repository.

8. A program product stored on a computer-readable medium, which when executed, enables a computer infrastructure to manage a value model, the program product comprising computer program code for enabling the computer infrastructure to perform the method steps of claim 1.

9. A method of valuing an enterprise function, the method comprising:
obtaining a value model, wherein the value model includes:
a plurality of levels, each of which includes at least one node representing one of an enterprise function or a value driver; and
a set of relationships, each of which defines a relationship between a first node on a first level and a second node on an adjacent level to the first level;
receiving a modification to the value model; and
recursively determining a value impact of the modification on a value measurement node in the value model.

10. The method of claim 9, wherein the value model includes:
a first set of enterprise function nodes for a first enterprise level of the value model;
a second set of enterprise function nodes for a second enterprise level of the value model;
a value driver graph, wherein the value driver graph includes a plurality of driver levels each of which includes at least one driver metric node, and wherein the value driver graph includes a set of driver relationships, wherein each driver relationship defines an impact that at least one driver metric node in a lower driver level has on a driver metric node in a higher driver level;
a first set of value relationships between the first set of enterprise function nodes and a set of driver metric nodes in a lowest driver level; and
a second set of value relationships between the second set of enterprise function nodes and the first set of enterprise function nodes.

11. The method of claim 9, wherein the enterprise function comprises one of a business activity or an information technology capability.

12. The method of claim 9, wherein the value model further includes a set of aggregate relationships for the set of relationships, wherein each aggregate relationship defines a dependency between at least two of the set of relationships.

13. The method of claim 12, wherein the set of aggregate relationships includes at least one of an inflation factor, a deflation factor or a correlation factor.

14. The method of claim 9, wherein the set of relationships includes at least one of: a usage rate and a performance impact.

15. The method of claim 9, wherein at least one relationship in the set of relationships defines an uncertainty range.

16. The method of claim 9, wherein the recursively determining step includes:
obtaining a set of modified nodes based on the modification;
for each succeeding level in the value model,
determining a set of related nodes to the set of modified nodes; and
calculating a value impact for each node in the set of related nodes based on the value impact of each related node in a previous level.

17. A system for managing a value model for use in valuing an enterprise function, the system comprising:
a system for generating the value model, the system for generating including:
a system for obtaining a first set of enterprise function nodes for a first enterprise level of the value model;
a system for obtaining a value driver graph, wherein the value driver graph includes a plurality of driver levels each of which includes at least one driver metric node, and wherein the value driver graph includes a set of driver relationships, wherein each driver relationship defines an impact that at least one driver metric node in a lower driver level has on a driver metric node in a higher driver level; and
a system for obtaining a first set of value relationships between the first set of enterprise function nodes and a set of driver metric nodes in a lowest driver level.

18. The system of claim 17, wherein the system for generating further includes:
a system for obtaining a second set of enterprise function nodes for a second enterprise level of the value model; and
a system for obtaining a second set of value relationships between the second set of enterprise function nodes and the first set of enterprise function nodes.

19. The system of claim 17, wherein the system for generating further includes a system for obtaining a set of aggregate relationships for the first set of value relationships, wherein each aggregate relationship defines a dependency between at least two of the set of value relationships.

20. The system of claim 17, further comprising:
a system for receiving a modification to the value model; and
a system for determining a value impact of the modification on a value measurement node in the value model.

21. The system of claim 17, wherein the system for obtaining a first set of value relationships includes a system for obtaining a set of default value relationships from a knowledge repository.

22. A system for valuing an enterprise function, the system comprising:
a system for obtaining a value model, wherein the value model includes:
a plurality of levels, each of which includes at least one node representing one of an enterprise function or a value driver; and
a set of relationships, each of which defines a relationship between a first node on a first level and a second node on an adjacent level to the first level;
a system for receiving a modification to the value model; and
a system for recursively determining a value impact of the modification on a value measurement node in the value model.

23. The system of claim 22, wherein the value model includes:
a first set of enterprise function nodes for a first enterprise level of the value model;
a second set of enterprise function nodes for a second enterprise level of the value model;
a value driver graph, wherein the value driver graph includes a plurality of driver levels each of which includes at least one driver metric node, and wherein the value driver graph includes a set of driver relationships, wherein each driver relationship defines an impact that at least one driver metric node in a lower driver level has on a driver metric node in a higher driver level;
a first set of value relationships between the first set of enterprise function nodes and a set of driver metric nodes in a lowest driver level; and
a second set of value relationships between the second set of enterprise function nodes and the first set of enterprise function nodes.

24. The system of claim 22, wherein the value model further includes a set of aggregate relationships for the set of relationships, wherein each aggregate relationship defines a dependency between at least two of the set of relationships.

25. The system of claim 22, wherein at least one relationship in the set of relationships defines an uncertainty range.

26. The system of claim 22, wherein the system for recursively determining includes:
a system for obtaining a set of modified nodes based on the modification; and
a system for determining, for each succeeding level in the value model, a set of related nodes to the set of modified nodes and calculating a value impact for each node in the set of related nodes based on the value impact of each related node in a previous level.

27. A method of generating a system for managing a value model, the method comprising:
providing a computer infrastructure operable to:
generate the value model by:
obtaining a first set of enterprise function nodes for a first enterprise level of the value model;
obtaining a value driver graph, wherein the value driver graph includes a plurality of driver levels each of which includes at least one driver metric node, and wherein the value driver graph includes a set of driver relationships, wherein each driver relationship defines an impact that at least one driver metric node in a lower driver level has on a driver metric node in a higher driver level; and
obtaining a first set of value relationships between the first set of enterprise function nodes and a set of driver metric nodes in a lowest driver level.
